(19) United States
(12) Patent Application Publication
(10) Pub. No.: US 2012/0116805 A1
(43) Pub. Date: May 10, 2012

(54) System and Method for Selecting and Implementing an Electronic Health Care Records System

(75) Inventors: Robert C. Cash, JR., Tampa, FL (US); Daniel Rodgers, St. Petersburg, FL (US)

(73) Assignee: MEDCO DATA, LLC, Tampa, FL (US)

(21) Appl. No.: 12/943,091

(22) Filed: Nov. 10, 2010

(51) Int. Cl. G06Q 50/00; G06Q 10/00

(52) U.S. Cl. 705/3

(57) ABSTRACT

Disclosed is a system and method for selecting and implementing an electronic medical records (EMR) system for a health care facility. The method allows a particular medical practice to be systemically analyzed relative to factors impacting EMR selection and implementation. This analysis is conducted by way of a graphical representation of the activities carried out by health care workers associated with the particular practice.

### BACKGROUND OF THE INVENTION

1. Field of the Invention

This disclosure relates to a method for selecting and implementing an electronic health care records system. More specifically, the disclosure relates to a system for analyzing the patient and billing related activities within a health care facility to select and optimize an electronic health care records system.

2. Description of the Background Art

Electronic medical records (EMR) are collections of digital information about an individual that are created, gathered, managed, and consulted by licensed clinicians and staff from a single organization who are involved in the individual's health and care.

EMRs can include information regarding medical history, medications, allergies, immunizations, laboratory tests, x-ray, MRI and cat scan images, in addition to billing and insurance information. All of this information can be stored digitally and shared by health care workers via a distributed computer network. EMR systems enable ambulatory health care providers to control costs by, inter alio, eliminating patient intake procedures, reducing the need to access paper files and by streamlining the billing process. EMRs also dramatically increase patient care by providing physicians with complete and updated medical records thereby permitting proper diagnosis.

As a result of the foregoing EMR systems are now being implemented across the country, and around the world, in order to reduce costs and improve patient care. Numerous EMR systems are currently available and many more will be entering the marketplace in the near future. Currently available EMR systems offer vastly different features and achieve the twin objectives of costs savings and patient care in different ways. EMR systems must also be tailored to the specifics of a particular medical practice. Thus, the process of selecting an appropriate EMR system for a particular medical practice can be difficult and timing consuming. Thereafter, the process of effectively implementing the selected EMR system into the medical practice can be equally challenging.

The present invention is aimed at overcoming these difficulties by providing a system and method for selecting and implementing an EMR system.

### SUMMARY OF THE INVENTION

An advantage of the present system is that it permits a medical practice to be systematically analyzed for the purpose of locating the most suitable EMR system.

One of the advantages of the present system is that it allows an EMR system to be selected based upon the needs of a particular medical practice.

Yet another advantage of the present system is that, once selected, it allows for the effective implementation of the EMR system into the medical practice.

Still yet another advantage of the present system is that it allows activities within a medical practice to be schematically presented and analyzed.

Another advantage is the ability to analyze the activities within a medical practice and correlate those activities with the factors that impact EMR selection and implementation.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1(a) is a flow chart illustrating the various working groups of the health care facility and the associated sub-factors.

FIG. 1(b) is a flow chart illustrating the various working groups of the health care facility and the associated sub-factors.

FIG. 2(a) is a flow chart of the check-in staff working group.

FIG. 2(b) is a flow chart of the check-out staff working group.

FIG. 3 is a flow chart of the clinical administration working group.

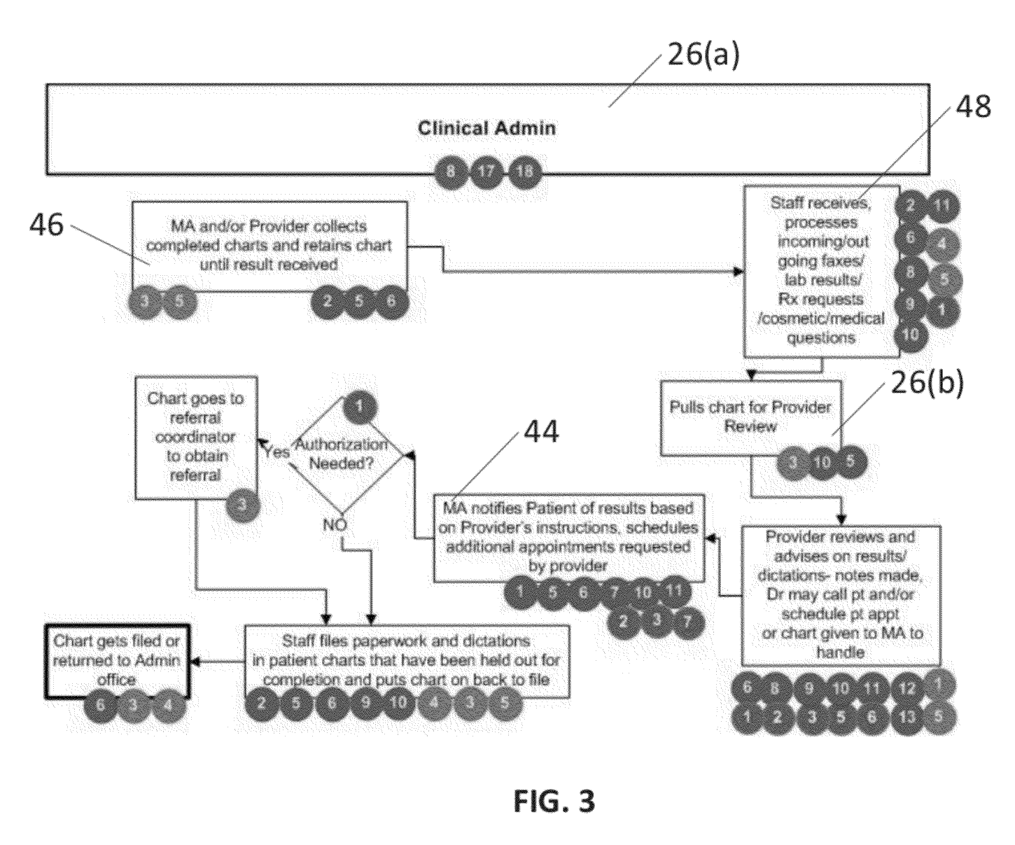

FIG. 4 is a flow chart of the provider working groups.

FIG. 5 is a flow chart of the billing personnel working groups.

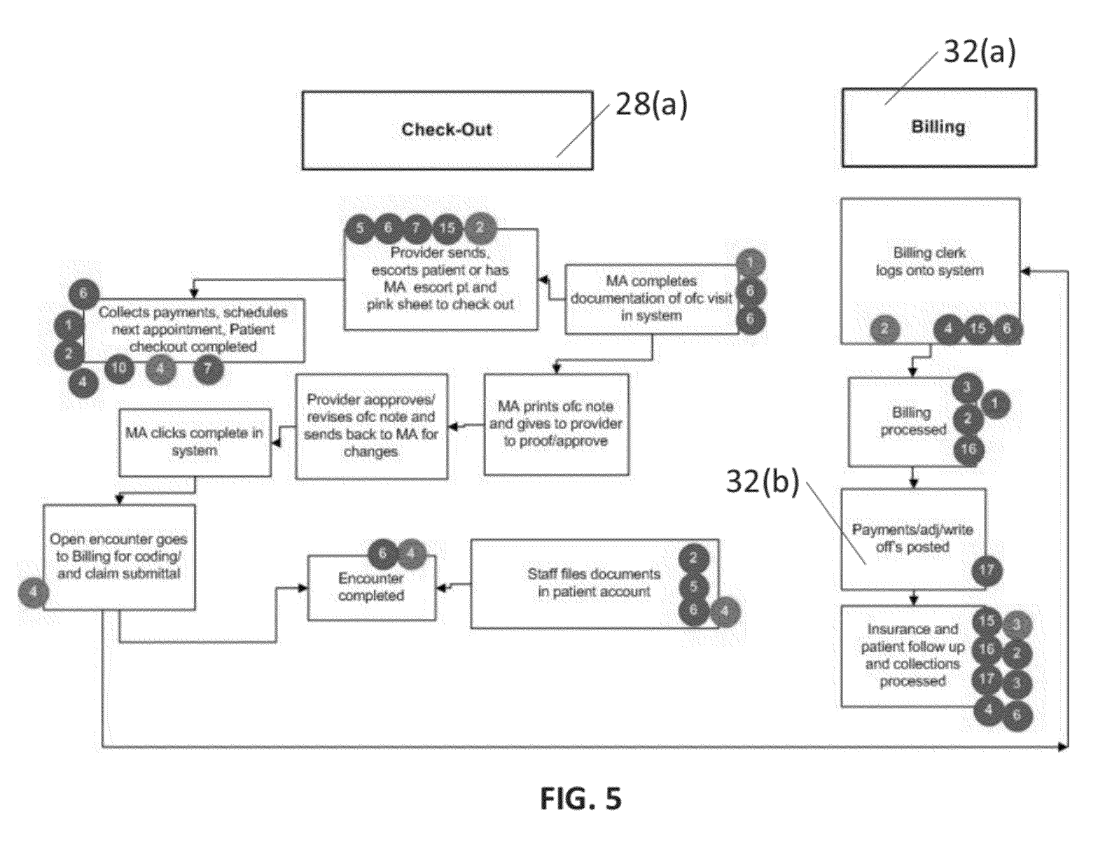

Similar reference characters refer to similar parts throughout the several views of the drawings.

### DETAILED DESCRIPTION OF THE PREFERRED EMBODIMENT

The present invention relates to a system and method for selecting and implementing an electronic medical record (EMR) software platform for an ambulatory health care facility. The method allows a particular medical practice to be systemically analyzed relative to factors impacting EMR selection and implementation. This analysis is conducted by way of a graphical representation of the activities carried out by health care workers associated with the particular practice. The details of the present invention, and the manner in which they interrelate, are described in greater detail hereinafter.

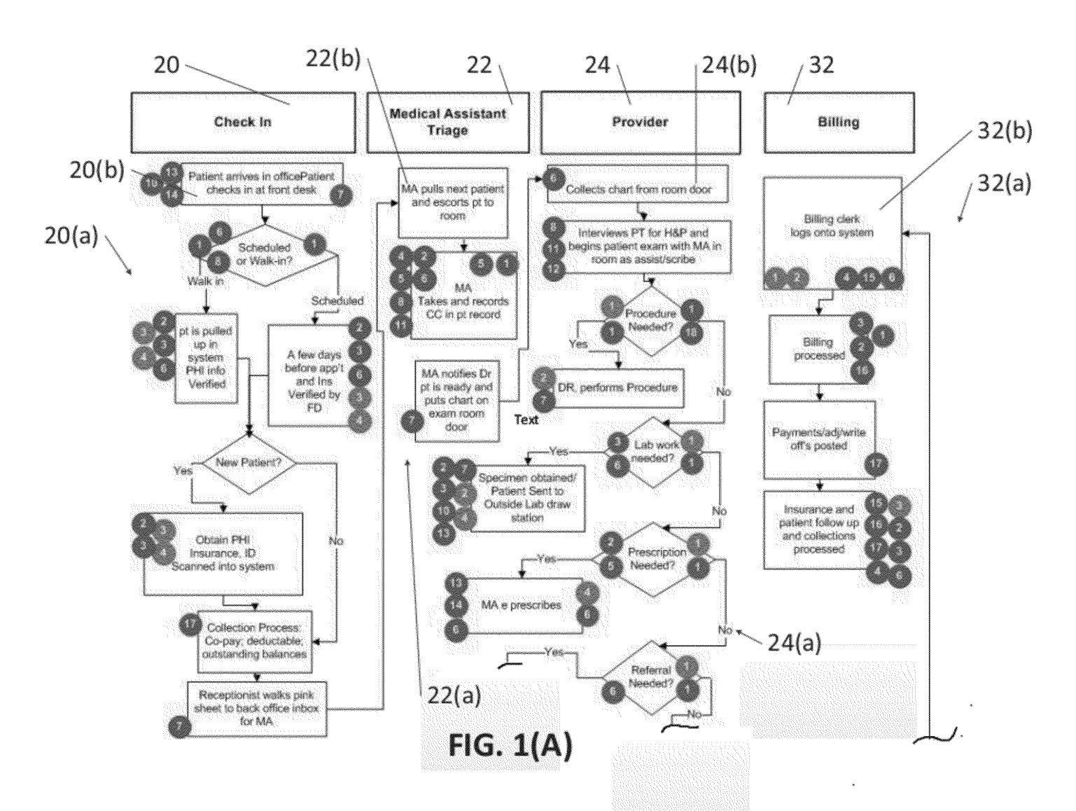

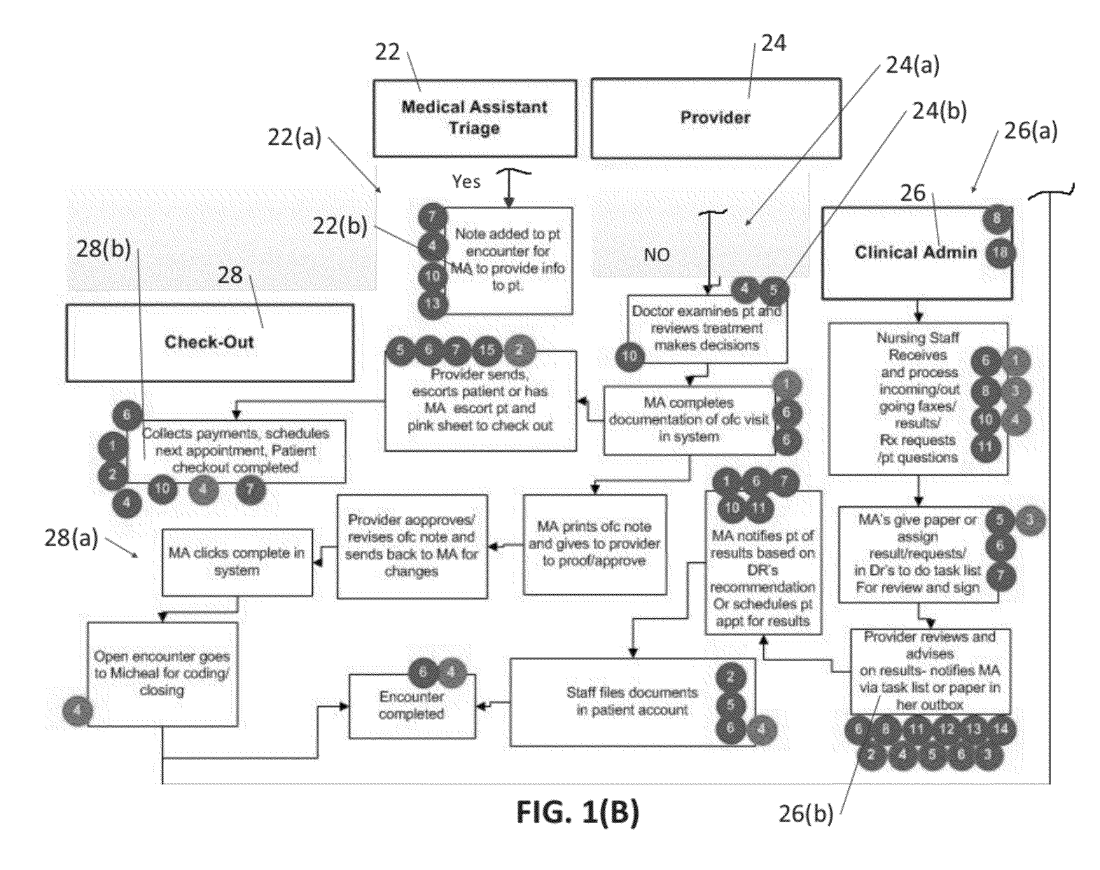

FIG. 1 is a flow chart 10 of the activities within a particular ambulatory health care facility. The first step in the present method involves reviewing the personnel associated with the health care facility and allocating all of the personnel into work groups. As is typical in any medical practice, the personnel are health care workers engaged in patient and billing related activities. For the particular practice illustrated in FIGS. 1(a)-1(b), the identified groups include including check-in staff 20, medical assistant staff 22, provider (nurse practitioner, physician assistant or physician) 24, clinical administrators 26, check-out staff 28, and billing personnel 32. The present method is by no means limited to these groups as other personnel may be needed depending upon the nature of the medical practice.

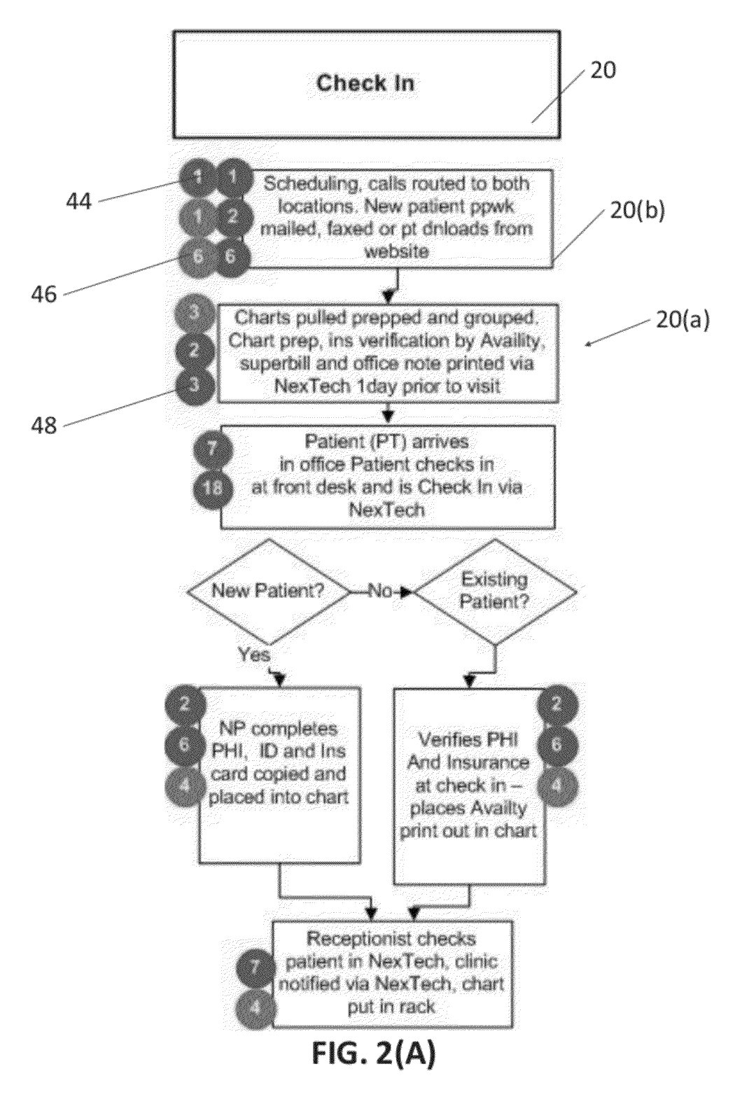

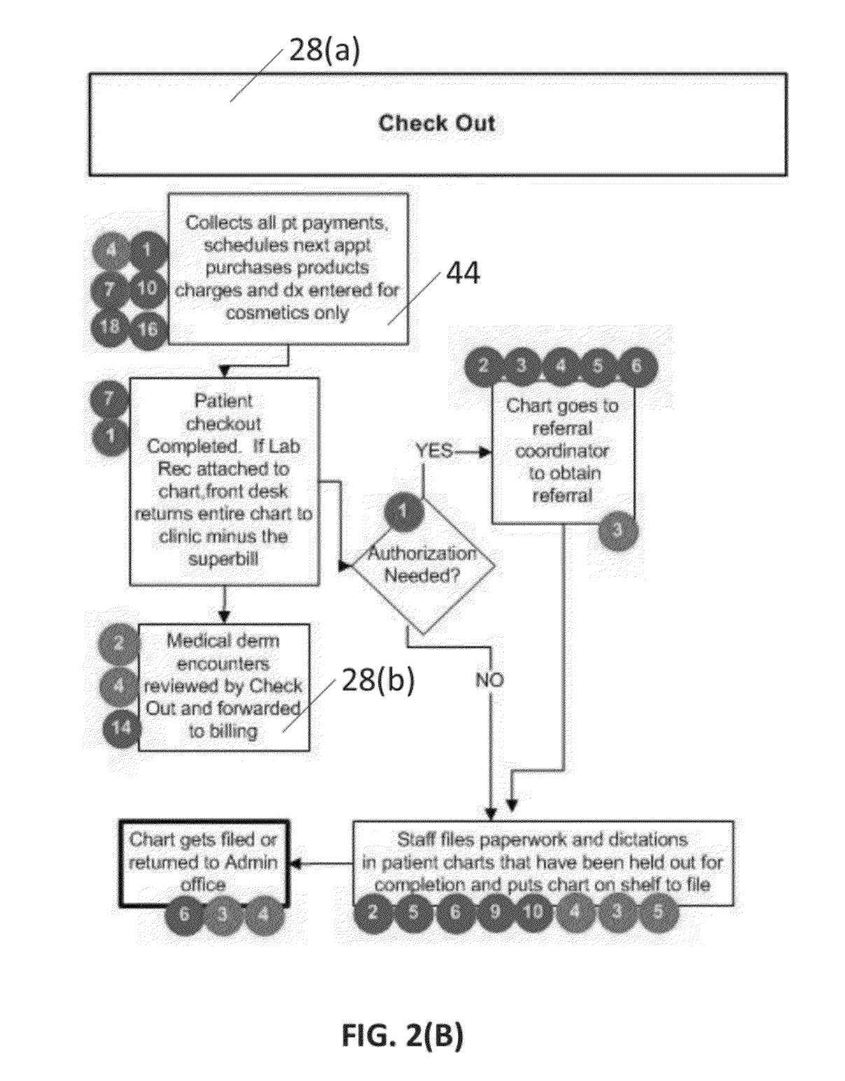

In the next step, a flow chart is generated for each of the identified groups. These include a check-in flow chart 20(a), a medical assistant triage flow chart 22(a), a provider flow chart 24(a), a clinical administration flow chart 26(a), a check-out flow chart 28(a), and a medical claims billing flow chart 32(a). The flow charts identify the steps involved in the various patient and billing related activities carried out by the workers in the group. These include check-in steps 20(b), medical assistant triage steps 22(b), provider steps 24(b), clinical administration steps 26(b), check-out steps 28(b) and billing steps 34(b). These steps include both the actions and decisions taken by the workers. FIG. 2 illustrates an alternative flow chart 20(a) for the check-in staff 20 of a particular practice. In the first step 20(b), the patient arrives at the front desk and checks in. The front desk (FD) clerk schedules appointments and determines which patients need to be seen immediately and which can be scheduled for later. The FD clerk also determines whether incoming patients are new patients or existing patients. Depending upon the answer, the FD clerk either obtains or confirms insurance information for the patient. Similar flow charts are generated for medical assistants, physicians, clinical administrators, check-out staff and billing personnel. The flow charts for any particular practice or health care facility are interconnected to an overall workflow chart 10 as shown in FIG. 1.

Thereafter, a plurality of primary EMR factors are identified. These primary factors are selected due to their impact on the selection and implementation of an EMR records system. In one embodiment, the primary factors including meaningful use factors, cost savings factors, and data handling factors. The Health Information Technology for Economic and Clinical Health (HITECH) Act as enacted by Congress establishes a number of programs to improve health care quality and efficiency through the promotion of health information technology, including EMR systems. Under HITECH, eligible health care facilities can qualify for Medicare and Medicaid incentive payments when they adopt certified EMR technology and use it to achieve specified objectives. The specified objectives are known as “meaningful use” objectives that providers must meet to qualify for bonus payments. Some of the meaningful use objectives include: i) improve care coordination; ii) reduce healthcare disparities; iii) engage patients and their families; iv) improve population and public health; and v) ensure adequate privacy and security. The second primary factor relates to cost savings or return on investment (“ROI”) factors. These are areas where the practice may be able to effectively reduce or eliminate unnecessary costs and/or recoup expenses. Finally, the primary factor of data handling identifies all the areas within the practice where a health care worker is gathering and/or inputting data related to either patient care or billing.

The present method thereafter involves identifying a plurality of sub-factors for each of the primary factors. These include meaningful use sub-factors 44, cost savings/ROI sub-factors 46, and data gathering sub-factors 48. The sub-factors are specific activities carried out by the health care workers and that are associated with a primary factor. The factors and sub-factors can be color coded. Table 1 lists the possible meaningful use sub-factors 44 (which may be color coded in blue):

TABLE 1

| Blue | Meaningful Use | | Total Qty |
|---|---|---|---|
| 1 | Patient Health Record | 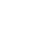 | 10 |
| 2 | e-Prescribe | 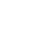 | 2 |
| 3 | e-Lab | 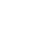 | 2 |
| 4 | Coded Format CDS | 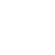 | 5 |
| 5 | Drug Interaction | 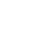 | 3 |
| 6 | Diagnosis Comparison | 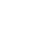 | 5 |
| 7 | Patient Access to Record | 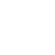 | 2 |
| 8 | PQRI | 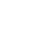 | 2 |

Table 2 lists the possible cost savings/ROI sub-factors 46 (which may be color

TABLE 2

| Green | Return On Investment | | Total Qty |
|---|---|---|---|
| 1 | Documentation | 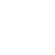 | 1 |
| 2 | Charge Capture | 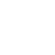 | 1 |
| 3 | Chart Pull | 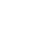 | 1 |
| 4 | Paperless | 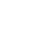 | 4 |
| 5 | Transcription | 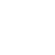 | 0 |
| 6 | Marketing | 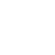 | 1 |

Finally, Table 3 lists the possible EMR data gathering sub-factors 48 (which may be color coded in red):

TABLE 3

| Red | Measurement | | Total Qty |
|---|---|---|---|
| 1 | Scheduling | 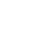 | 1 |
| 2 | PHI & Demographics | 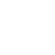 | 4 |
| 3 | Insurance Verification | 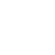 | 3 |
| 4 | Referral Tracking | 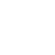 | 2 |
| 5 | Medical Record Doc (SOAP) | 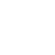 | 1 |
| 6 | Record Handling and Sharing | 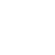 | 4 |
| 7 | Internal Communication | 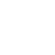 | 2 |
| 8 | Triage | 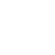 | 2 |
| 9 | Transcription | 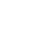 | 0 |
| 10 | Patient Orders | 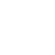 | 1 |
| 11 | Patient Results/Tracking | 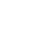 | 2 |
| 12 | Review and Signature | 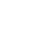 | 0 |
| 13 | Script Writing | 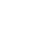 | 0 |
| 14 | Prescription Refills | 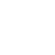 | 0 |
| 15 | E&M Coding | 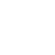 | 0 |
| 16 | Claims/Bill Processing/Tracking | 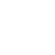 | 0 |
| 17 | Insurance/Patient Collectors | 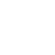 | 1 |
| 18 | Medical Products Inventory | 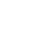 | 0 |
| 19 | Retail Products Inventory | 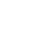 | 0 |

After the sub-factors have been identified, they are associated with each of the steps 20(b)-32(b) identified in flow charts 20(a)-32(a). In each case, the association is based upon the nature of the steps. For example, for the check-in staff flow chart 20(a) identified in FIG. 1, the first step 20(b) is the patient's arrival at the front desk. This step involves a number of data gathering sub-factors 48, such as scheduling, gathering patient health information (PHI) and gathering and verifying insurance information. A number of meaningful use sub-factors 44 are also applicable, such as generating a patient health record and permitting the patient access to their health record. As explained above, these meaningful use sub-factors 44 are areas that, if effectively implemented in an EMR system, would make the health care provider eligible for government stimulus funds. Finally, the first step of the check-in process 20(b) also involves the cost savings sub-factor 46 of marketing. Namely, the check-in process allows the health care facility to secure repeat patients via marketing and good customer service. This, in turn, gives the health care facility a return on its investment.

As noted in FIG. 1, the next step in the process is to graphically identify associations between the steps in the flow charts and the various sub-factors. These associations are graphically indicated upon the flow charts as color coded dots. Again, the first step in the check-in process involves sub-factors 1, 2, 3, 4, 6, and 10 from the EMR data gathering factors 42. These are all color coded in red. The first step also involves sub-factors 1 and 7 from the meaningful use factors 36. These are all color coded in blue. Finally, the cost savings/ROI sub-factor 6 from the costs savings/ROI primary factor 38 is color coded in green. Each of the steps from all of the flow charts are similarly analyzed and associated with one or more sub-factors (although it is possible that a particular step is not properly associated with any sub-factor).

After the associations are complete, the associated sub-factors under each primary factor are totaled. For the depicted example, these totals are indicated in above in Tables 1-3. For instance, for the complete flow chart 10 illustrated in FIGS. 1(a)-1(b), there are a total of 31 meaningful use sub-factors 44 (blue), a total of 8 cost savings/ROI sub-factors 46 (green); and a total of 23 data gathering sub-factors 48 (red). These totals are then used in selecting and implementing an EMR records system for the particular medical facility. Specifically, the user can compare the quantified sub-factors for each primary factor to the known operational aspects of existing EMR systems and thereby make an informed buying decision. Also, by graphically illustrating the color coordinated sub-factors 44, 46, and 48 upon flow chart 10, the user can identify areas to best maximize and utilize existing EMR systems.

The method described above can be carried out by software program running on a stand alone or networked computer or computer server. The software can be programmed to solicit needed information from the user and thereafter graphically generate the relevant flow charts 20(a), 22(a), 24(a), 26(a), 28(a), and 32(a). The program can further solicit information to generate the associations between the steps within each flow chart and the sub-factors 44, 46, and 48. A graphics module can be included for generating a graphic display of the various flow charts. Finally, the software can compute the totals for each of the primary factors and compare the totals to a database of known EMR systems. The database includes a table of known EMR records systems and recommended sub-factor ranges for each primary factor. Thus, the database is sufficient to permit recommendations to be automatically made based upon the totals.

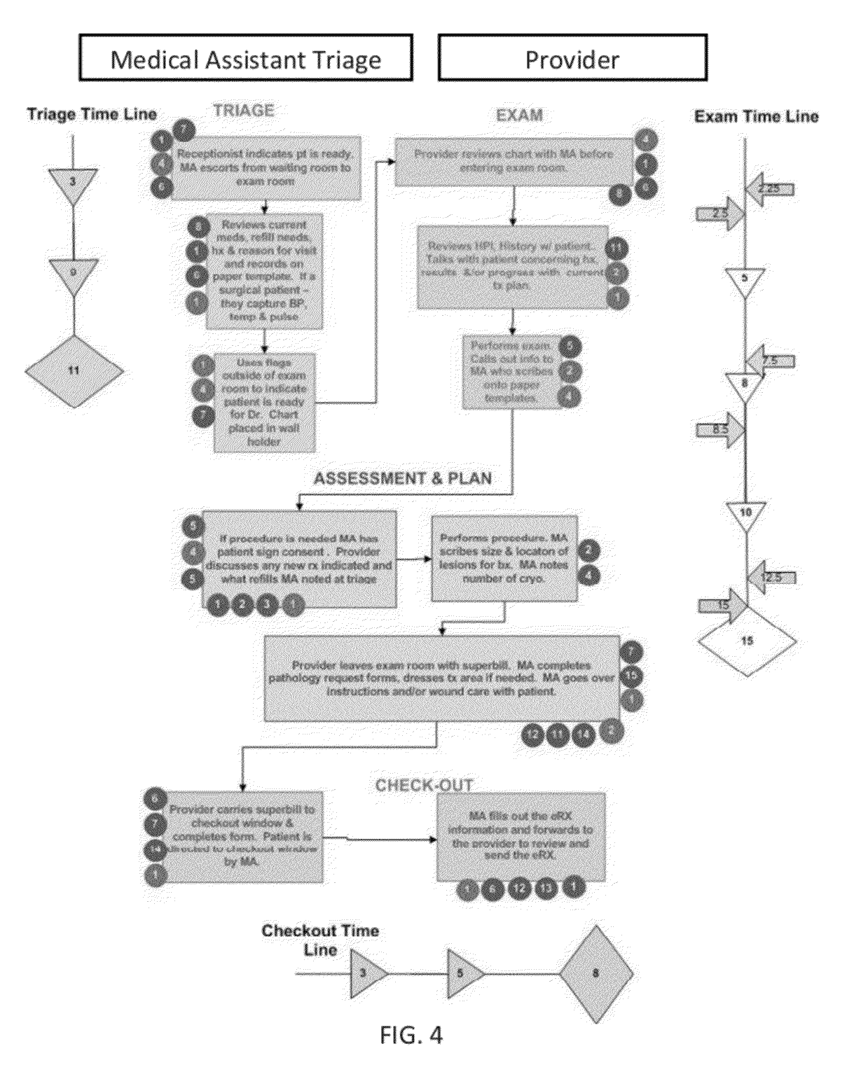

FIG. 4 is a further flow chart of the medical assistant triage and provider working groups. The objective of these flow charts is to track the overall length of the patient encounter. The permits increased time efficiencies to be realized in both triage and during the exam. These efficiencies are realized, in part, by diagramming the corresponding steps and correlating such steps to sub-factors 44, 46, and 48.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A method for selecting and implementing an electronic medical records (EMR) system within an ambulatory health care facility, the health care facility including a number of health care workers engaged in patient and billing related activities, the method comprising the following steps:
dividing the health care workers into groups, the groups including check-in staff, medical assistants, providers, clinical administrators, check-out staff, and billing personnel;
generating a flow chart for each of the groups, the flow charts identifying the steps involved in the patient and billing related activities carried out by the health care workers of the group, the flow charts being interconnected;
identifying a plurality of primary factors impacting the selection and implementation of an EMR system, the primary factors including meaningful use factors, cost savings factors, and data handling factors;
identifying a plurality of sub-factors for each of the primary factors, the primary and sub-factors being color coded;
associating the steps identified in the flow charts with a sub-factor, the association being based upon the nature of the steps;
identifying the associations between the steps and sub-factors upon the flow charts;
totaling the number of associated sub-factors for each primary factor;
using the totaled number of associated sub-factors for each primary factor in selecting and implementing an EMR system.

2. A method for selecting and implementing an electronic medical record (EMR) system within an ambulatory health care facility comprising the following steps:
identifying groups of health care workers;
generating a flow chart for each of the groups, the flow charts identifying the steps involved in the patient and billing related activities carried out by the health care workers of the group;
identifying a plurality of primary factors impacting the selection and implementation of an EMR system, the primary factors including meaningful use factors, cost savings factors, and EMR data handling factors;
associating the steps identified in the flow charts with a primary factor, the association being based upon the nature of the steps;
totaling the number of associated steps and using the total in selecting an EMR system.

3. The method as described in claim 2 further comprising the steps of:
identifying a plurality of sub-factors for each of the primary factors;
associating the steps identified in the flow charts with a sub-factor, the association being based upon the nature of the steps;
identifying the associations between the steps and sub-factors upon the flow charts;
totaling the number of associated sub-factors for each primary factor;
using the totaled number of associated sub-factors for each primary factor in selecting and implementing an EMR system.

4. The method as described in claim 3 further comprising the step of:
color coding the primary factors and sub-factors and indicating the color coded primary factors and sub-factors on the flow charts.

5. The method as described in claim 2 wherein the primary factors include meaningful use factors, cost savings factors, and EMR data handling factors.

6. The method as described in claim 2 wherein the flow charts of each of the groups are interconnected.

7. A system for selecting and implementing an electronic medical record (EMR) system within an ambulatory health care facility, the system comprising:
a computer including a computer database of known EMR systems;
software resident on the computer and programmed to query the user to identify groups of health care workers;
the software including a graphics module for generating a flow chart for each of the groups, the flow charts identifying the steps involved in the patient and billing related activities carried out by the health care workers of the group;
the database further includes a listing of primary factors impacting the selection and implementation of an EMR records system, the primary factors including meaningful use factors, cost savings factors, and EMR data handling factors;
the software prompting the user to associate the steps identified in the flow charts with a primary factor, the association being based upon the nature of the steps;
the software automatically totaling the number of associated steps and using the total in selecting an EMR records system;
the software generating a list of recommended EMR systems by comparing the automatically generated totals to the database of known EMR records systems.
